(19) United States
(12) Patent Application Publication
(10) Pub. No.: US 2023/0019370 A1
(43) Pub. Date: Jan. 19, 2023

(54) NON-TRANSITORY COMPUTER-READABLE MEDIUM AND ANIMATION GENERATING SYSTEM

(71) Applicant: SQUARE ENIX CO., LTD., Tokyo (JP)

(72) Inventors: Tomohiro MORI, Tokyo (JP); Kousuke NAMIKI, Tokyo (JP); Gustavo MARTINS, Tokyo (JP); Shinpei SAKATA, Tokyo (JP)

(21) Appl. No.: 17/866,395

(22) Filed: Jul. 15, 2022

(30) Foreign Application Priority Data
Jul. 16, 2021 (JP) 2021-118118

(51) Int. Cl. G06T 13/40; G06T 7/00

(52) U.S. Cl. CPC G06T 13/40; G06T 7/0002; G06T 2213/12

(57) ABSTRACT

A non-transitory computer-readable medium storing an animation generating program for causing a server to perform functions to generate an animation of an object configured by a combination of parts is provided. The functions include: registering content of a specified operation against the parts as specified operation information in advance; obtaining the specified operation information for identifying the specified operation; and a generating a part animation of each of object parts among the object parts of the object to control the specified operation of the object parts by dynamically calculating a rotation angle of a joint site required for the specified operation of the object parts in accordance with a predetermined calculation rule, and generating an animation of the entire object based on the part animation of each of the object parts.

### CROSS-REFERENCE TO RELATED APPLICATION

This application claims priority to and the benefit of Japanese Patent Application No. 2021-118118 filed on Jul. 16, 2021, the disclosure of which is expressly incorporated herein by reference in its entirety.

### BACKGROUND

At least one of embodiments of the present disclosure relates to a non-transitory computer-readable medium storing an animation generating program and an animation generating system for performing functions to generate an animation of an object that carries out an operation in a virtual space.

Conventionally, in a field of video games and the like, it has been executed to cause an object represented by a three-dimensional model to continuously carry out a predetermined operation in a virtual space to thus generate an animation.

As a method of generating an animation regarding an object, there is a method in which animation data registered in advance (hereinafter, referred to as “static animation data”) to create an animation by specifying a coordinate of each region and a rotation angle of each joint with a three-dimensional model in each posture and continuously reproducing all postures are prepared, and other animations are generated by using the static animation data in combination. Here, a “static” animation refers to as an animation generated by specifying coordinates of all regions and rotation angles of all joint with a three-dimensional model for all postures of an object.

Examples of a system that automatically generates an animation (or a motion) of a character when the character moves on an inclined plane by using basic movement operation data, which represents a basic movement motion in which the character moves on a reference plane may be found in Japanese Patent Application Publication No. 2018-028812.

Here, in case of a method of automatically generating an animation of an object by using static animation data, it is necessary for a developer to create the static animation data in advance, and there is thus a problem that a load on the developer increases as development scale thereof increases. In Patent Document 1, by generating an animation when moving an inclined plane by using an animation at the time of movement of a plane, a load to create an animation is reduced. However, it can be said that a load on the developer to prepare the static animation data still remains. In addition, static animation data created for a certain object are diverted to the other objects. Therefore, there has been a problem that in order to reproduce an animation by the static animation data when applying them to the other object, some kinds of abnormalities may occur, such as a situation that the other object carries out an operation beyond the range of motion of a joint, which is assumed in a three-dimensional model.

### SUMMARY

It is an objective of at least one of embodiments of the present disclosure to solve the problem described above, and to be able to dynamically generate an animation in which an object is caused to carry out an operation.

According to one non-limiting aspect of the present disclosure, there is provided a non-transitory computer-readable medium storing an animation generating program for causing a server to perform functions to generate an animation of an object. Here, the object carries out an operation in a virtual space, and the object is configured by a combination of parts. The parts at least include one or more joint sites.

The functions include a registering function configured to register content of a specified operation against the parts constituting the object as specified operation information in advance, each of the parts constituting the object being an object part.

The functions also include an obtaining function configured to obtain the specified operation information for identifying the specified operation, the object parts being caused to carry out the specified operation.

The functions also include a generating function configured to generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on a basis of the part animation of each of the object parts.

According to another non-limiting aspect of the present disclosure, there is provided an animation generating system for generating an animation of an object. Here, the object carries out an operation in a virtual space, and the object is configured by a combination of parts. The parts at least include one or more joint sites. Further, the animation generating system includes a communication network, a server, and a user terminal.

One or more processors comprised in the animation generating system register content of a specified operation against the parts constituting the object as specified operation information in advance, each of the parts constituting the object being an object part.

The processors comprised in the animation generating system also obtain the specified operation information for identifying the specified operation, the object parts being caused to carry out the specified operation.

The processors comprised in the animation generating system also generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on a basis of the part animation of each of the object parts.

According to still another non-limiting aspect of the present disclosure, there is provided a non-transitory computer-readable medium storing an animation generating program for causing a user terminal to perform functions to generate an animation of an object. Here, the object carries out an operation in a virtual space, and the object is configured by a combination of parts. The parts at least include one or more joint sites.

The functions include a registering function configured to register content of a specified operation against the parts constituting the object as specified operation information in advance, each of the parts constituting the object being an object part.

The functions also include an obtaining function configured to obtain the specified operation information for identifying the specified operation, the object parts being caused to carry out the specified operation.

The functions also include a generating function configured to generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on a basis of the part animation of each of the object parts.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description of preferred embodiments of the present disclosure that proceeds with reference to the appending drawings:

FIG. 1 is a block diagram illustrating an example of a configuration of an animation generating system corresponding to at least one of the embodiments of the present disclosure;

FIG. 2 is a block diagram illustrating a configuration of a server corresponding to at least one of the embodiments of the present disclosure;

FIG. 3 is a flowchart illustrating an example of an animation generating process corresponding to at least one of the embodiments of the present disclosure;

FIG. 4 is a flowchart illustrating an example of an operation of a server side in the animation generating process corresponding to at least one of the embodiments of the present disclosure;

FIG. 5 is a flowchart illustrating an example of an operation of a terminal side in the animation generating process corresponding to at least one of the embodiments of the present disclosure;

FIG. 6 is a block diagram illustrating a configuration of a server corresponding to at least one of the embodiments of the present disclosure;

FIG. 7 is a flowchart illustrating an example of an animation generating process corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of an animation generating process corresponding to at least one of the embodiments of the present disclosure;

FIG. 10 is a block diagram illustrating a configuration of a server corresponding to at least one of the embodiments of the present disclosure;

FIG. 11 is a flowchart illustrating an example of an animation generating process corresponding to at least one of the embodiments of the present disclosure;

FIG. 12 is a block diagram illustrating a configuration of a server corresponding to at least one of the embodiments of the present disclosure;

FIG. 13 is a flowchart illustrating an example of an animation generating process corresponding to at least one of the embodiments of the present disclosure;

FIG. 14 is an explanatory drawing for explaining an example of object parts corresponding to at least one of the embodiments of the present disclosure;

FIG. 15 is an explanatory drawing for explaining an example of specified operation information corresponding to at least one of the embodiments of the present disclosure;

FIG. 16 is an explanatory drawing illustrating an example of first combination command information corresponding to at least one of the embodiments of the present disclosure;

FIG. 17 is an explanatory drawing illustrating an example of second combination command information corresponding to at least one of the embodiments of the present disclosure; and

FIG. 18 is an explanatory drawing illustrating an example of “aimIK” for performing an aim operation corresponding to at least one of the embodiments of the present disclosure.

### DETAILED DESCRIPTION

Hereinafter, examples of embodiments according to the present disclosure will be described with reference to the drawings. Note that various components in the respective embodiments described below can be appropriately combined without any contradiction or the like. In addition, the description of the content described as a certain embodiment may be omitted in another embodiment. Further, the content of an operation or processing that does not relate to features of each of the embodiments may be omitted. Moreover, the order of various processes that constitute various flows described below may be changed without any contradiction or the like of processing content.

### First Embodiment

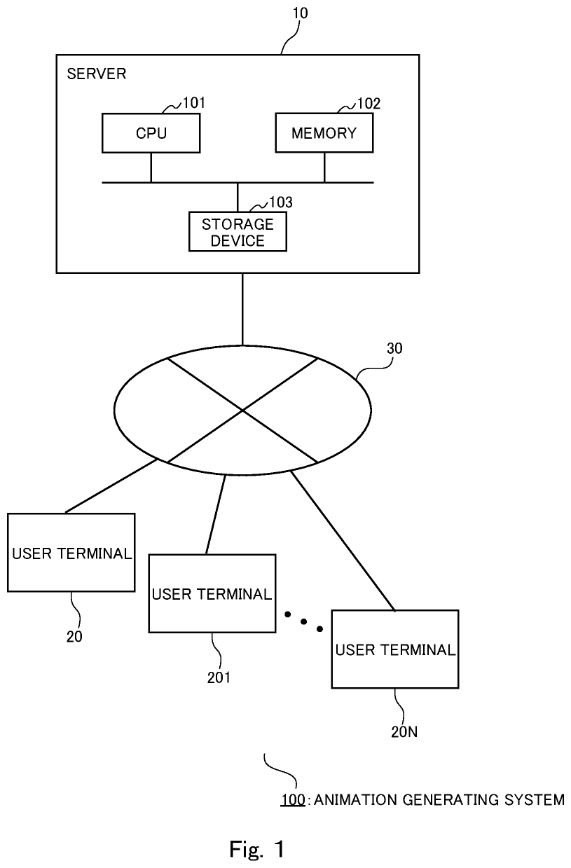

FIG. 1 is a block diagram illustrating an example of a configuration of an animation generating system 100 according to one embodiment of the present disclosure. As illustrated in FIG. 1, the animation generating system 100 includes a server 10, and user terminals 20, and 201 to 20N (“N” is an arbitrary integer) respectively used by users of the animation generating system 100. In this regard, the configuration of the animation generating system 100 is not limited to this configuration. The animation generating system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by executing data communication with base stations managed by a telecommunication carrier by means of a radio communication line.

The animation generating system 100 includes the server 10 and the plurality of user terminals 20 and 201 to 20N, whereby various kinds of functions for executing various kinds of processing in response to an operation of the user are performed.

The server 10 is managed by an administrator of the animation generating system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. A configuration of the server 10 is not limited particularly so long as the server 10 includes a general configuration for executing various kinds of processes as a computer, such as a control unit and a communication unit. Hereinafter, an example of a hardware configuration of the server 10 will be described briefly.

As illustrated in FIG. 1, the server 10 at least includes a CPU (Central Processing Unit) 101, a memory 102, and a storage device 103.

The CPU 101 is a central processing unit configured to execute various kinds of calculations and controls. Further, in a case where the server 10 includes a GPU (Graphics Processing Unit), a part of the various kinds of calculations and controls may be executed by the GPU. The server 10 appropriately executes, by the CPU 101, various kinds of information processing required to generate animation by using data read out onto the memory 102, and stores obtained processing results in the storage device 103 as needed.

The storage device 103 has a function as a storage medium for storing various kinds of information. A configuration of the storage device 103 is not limited particularly. However, it is preferable that the storage device 103 is configured so as to be capable of storing all of the various kinds of information required to generate animation from the viewpoint of reducing a processing load on each of the plurality of user terminals 20 and 201 to 20N. As such examples, there are an HDD and an SSD. However, a storage unit for storing the various kinds of information may be provided with a storage region in a state that the server 10 can access the storage region, for example, and may be configured so as to have a dedicated storage region outside the server 10.

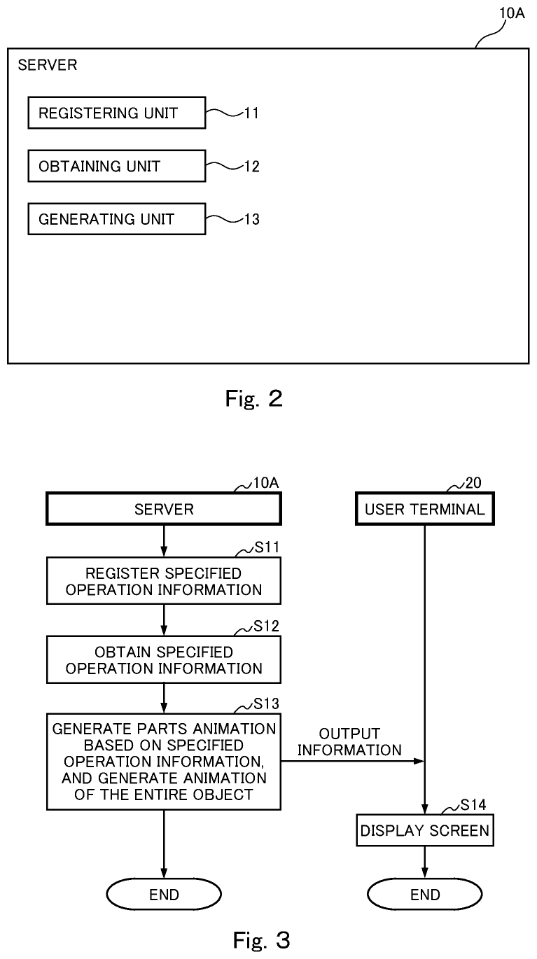

FIG. 2 is a block diagram illustrating a configuration of a server 10A, which is an example of the configuration of the server 10. As illustrated in FIG. 2, the server 10A at least includes a registering unit 11, an obtaining unit 12, and a generating unit 13.

The registering unit 11 has a function to register the content of a specified operation against parts constituting an object (hereinafter, referred to also as an “object part”) as specified operation information in advance.

Here, the object is a virtual object that may be arranged in a virtual space, and means an object configured by a combination of object parts that at least include one or more joint sites. The object is not limited particularly so long as the object is configured by a combination of object parts. With respect to connection between object parts, object parts may be connected to each other by means of a joint, or may fixedly be connected to each other. As an example of the type of object, various types such as a human-shaped object and a quadrupedal animal-shaped object can be considered. A configuration of such an object is prepared in advance as a three-dimensional model. In this regard, hereinafter, the explanation is mainly made on the assumption that the object is a three-dimensional model, but it does not exclude a two-dimensional model. The present disclosure can also be applied to a case where an animation using a two-dimensional model is to be generated.

Further, the object part means a region of a predetermined range in the three-dimensional model constituting the object. The object part is a part that occupies the predetermined range of the object. The object part at least includes one or more joint sites. A part or the whole of one object part is configured to carry out rotational movement around a joint site. For example, two object parts are connected to each other via a joint site. Here, a boundary between two of a plurality of object parts can be defined appropriately. For example, a range of one object part with respect to the entire object is defined with a joint site as a boundary. How to handle a joint site on a boundary can be determined appropriately. However, for example, it can be considered to handle the joint site so as to belong to any one of the object parts.

Further, the specified operation means an operation that the object part is caused to carry out. Further, the specified operation information means information for identifying the content of the specified operation. Moreover, information necessary for dynamically calculating a rotation angle of the joint site to carry out the specified operation is contained in the specified operation information. The information necessary for dynamic calculation contains information for specifying a target posture for carrying out a specified operation, a target direction of a region, or a locus of the region, and information for specifying a predetermined calculation rule for dynamically calculating a rotation angle of a joint site in each posture state when carrying out a specified operation by using these kinds of information, for example. Further, for example, mathematical functions, which include all of the information for specifying a target posture for carrying out a specified operation, the target direction of the region, or the locus of the region, and the information for specifying a predetermined calculation rule for dynamically calculating a rotation angle of a joint site in each posture state when carrying out a specified operation by using these kinds of information, may be registered as the specified operation information. Here, the predetermined calculation rule may be one in which a general-purpose calculation rule (general-purpose mathematical function) is registered, and the general-purpose calculation rule is read out and used when a specified operation is carried out, or may be a calculation rule registered as an original mathematical function set so as to execute calculation processing in which the content of a specified operation is specialized. Here, the mathematical function according to the present embodiment means a calculation rule for dynamically calculating and outputting a rotation angle of each joint site required for each posture state of a specified operation that an object part is caused to carry out on the basis of an input of a predetermined type of parameter. In this regard, the phrase “dynamically calculating” means that in a case where a target posture for causing an object part to carry out a specified operation, a target direction of a region, or a locus of the region is specified, a posture state of an object part in the middle of the process and a rotation angle of a joint site at that time are not held as animation data in advance, but a rotation angle of a joint site for setting to the optimum posture state according to the situation is calculated and obtained each time.

Further, a configuration to register the content of the specified operation as the specified operation information in advance is not limited particularly. The content may be registered in a predetermined storing unit included in the server 10, or may be registered in a predetermined storage region included in a device (for example, the user terminal 20) capable of communicating with the server 10.

The obtaining unit 12 has a function to obtain the specified operation information for identifying the specified operation that the object parts are caused to carry out.

Here, the phrase “obtain the specified operation information” means that specified operation information in which a specified operation that an animation specified by any means is caused to carry out is obtained. As the subject that specifies the specified operation information, a user who determines an operation against an object or AI for controlling an action of an object can be considered, for example. A concrete configuration to obtain the specified operation information is not limited particularly. However, for example, a configuration in which when the content of a specified operation against an object part is determined, specified operation information for realizing it is read out by referring to a storage region of a registration destination in the registering unit 11 can be considered.

The generating unit 13 has a function to generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on the basis of the part animation of each of the object parts.

Here, the object part for which an operation is required means an object part of the subject that carries out a specified operation identified by the specified operation information. Since it is not necessary to operate all object parts constituting an object, the intention is to process only object parts that require an operation for which the specified operation information has been obtained.

Further, the rotation angle of the joint site means a rotation angle of a joint from a default position in a case where an initial position (that is, the default position) of a position of one region with respect to the other region of two regions connected to a joint site thereof is used as a reference. Namely, the rotation angle of the joint site means information for specifying the rotation angle for the other region regardless of what kind of posture is one region.

Further, the phrase “dynamically calculating a rotation angle of a joint site” means that on the basis of information such as a target posture given to object parts, a target position of a region, a target direction, and a target locus, necessary calculation for a rotation angle of each joint site in each posture state up to that point is executed each time in accordance with various conditions, which change each time, such as external environment at the time of calculation start and a posture state at the time of the calculation start. As for the various conditions, any conditions can be adopted so long as they may affect an animation generation result.

Further, the part animation means animation data of only an object part for controlling to cause the object part to carry out a specified operation. An animation of the entire object is generated by combining part animations for a plurality of object parts.

Each of the plurality of user terminals 20, and 201 to 20N is managed by the user, and is configured by a communication terminal capable of playing network delivery type animation generation, such as a cellular telephone terminal, a PDA (Personal Digital Assistants), a portable game apparatus, or a so-called wearable device, for example. In this regard, the configuration of the user terminal that the animation generating system 100 can include is not limited to the example described above. Each of the user terminals 20, and 201 to 20N may be configured so that the user can recognize the generated content of the animation. As the other examples of the user terminal, there are one obtained by combining various kinds of communication terminals, and a personal computer.

Further, each of the plurality of user terminals 20, and 201 to 20N is connected to the communication network 30, and includes hardware (for example, a display device for displaying a browser screen or an animation generating screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the animation generating system 100 (hereinafter, referred to as the “system 100”) according to the present embodiment will be described.

FIG. 3 is a flowchart illustrating an example of an animation generating process executed by the system 100. In the animation generating process according to the present embodiment, processes related to a control of generation of an animation in response to an operation of the user of the user terminal 20 (hereinafter, referred to as a “terminal 20”) are executed. Hereinafter, a case where the server 10A and the terminal 20 execute the animation generating process will be described as an example.

The animation generating process is started, for example, when the terminal 20 that has accessed the server 10A requests a screen display accompanied by an animation generation request.

The server 10A first registers, as information necessary for the animation generating process, the content of a specified operation for object parts as specified operation information in advance (Step S11). For example, the server 10A registers: information for identifying object parts to be targets of the specified operation; information for determining a target posture, a target position of each region, a target direction, and target locus in the specified operation that the object parts are caused to carry out; and information on predetermined calculation rules for executing dynamic calculation, as the specified operation information in advance.

Next, the server 10A obtains the specified operation information for identifying the specified operation for the object parts (Step S12). For example, the specified operation is given on the basis of a user operation against an object, and the server 10A selects and obtains specified operation information corresponding to the specified operation from plural kinds of specified operation information registered in advance.

Next, the server 10A generates a part animation on the basis of the obtained specified operation information, and generates an animation of the entire object on the basis of part animations of the respective object parts (Step S13). In the present embodiment, the server 10A dynamically calculates a rotation angle of each joint site required in each posture state for carrying out the specified operation for each of the object parts to generate a part animation, and combines the generated part animations to generate an animation of the entire object. In the present embodiment, the server 10A transmits, to the terminal 20, output information for causing the terminal 20 to display the animation of the entire object.

When the terminal 20 receives the output information from the server 10A, the terminal 20 outputs a screen for displaying an animation generation result to a display screen of a predetermined display device (Step S14). In the present embodiment, when the terminal 20 outputs the screen for displaying the animation generation result, the server 10A and the terminal 20 terminate the processes herein.

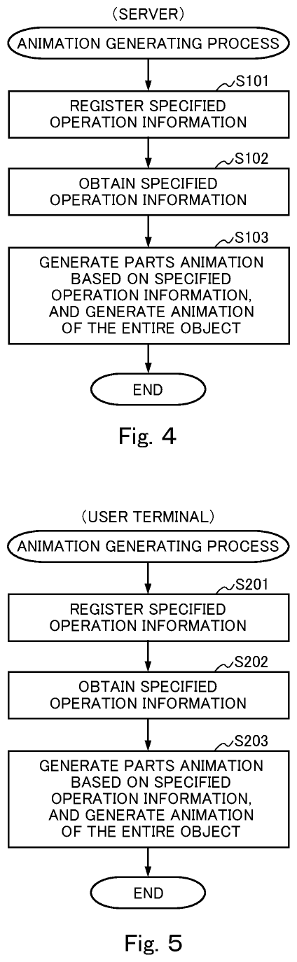

FIG. 4 is a flowchart illustrating an example of an operation of the server 10A side in the animation generating process. Here, an operation of the server 10A in the system 100 will be described again.

The server 10A first registers, as information necessary for the animation generating process, the content of a specified operation for object parts as specified operation information in advance (Step S101). Next, the server 10A obtains the specified operation information for identifying the specified operation for the object parts (Step S102). Next, the server 10A generates a part animation on the basis of the obtained specified operation information, and generates an animation of the entire object on the basis of part animations of the respective object parts (Step S103). When the animation of the entire object is generated, the server 10A terminates the processes herein.

FIG. 5 is a flowchart illustrating an example of the terminal 20 side in a case where the terminal 20 executes the animation generating process. Hereinafter, a case where the terminal 20 executes the animation generating process by a single body will be described as an example. In this regard, the configuration of the terminal 20 includes the similar functions to those of the server 10A except that the terminal 20 receives various kinds of information from the server 10A. For this reason, its explanation is omitted from a point of view to avoid repeated explanation.

The terminal 20 first registers, as information necessary for the animation generating process, the content of a specified operation for object parts as specified operation information in advance (Step S201). Next, the terminal 20 obtains the specified operation information for identifying the specified operation for the object parts (Step S202). Next, the terminal 20 generates a part animation on the basis of the obtained specified operation information, and generates an animation of the entire object on the basis of part animations of the respective object parts (Step S203). When the animation of the entire object is generated, the terminal 20 terminates the processes herein.

As explained above, as one aspect of the first embodiment, the server 10A that has functions to generate an animation of an object, which carries out an operation in a virtual space and is configured by a combination of parts that at least include one or more joint sites, is configured so as to at least include the registering unit 11, the obtaining unit 12, and the generating unit 13. Thus, the registering unit 11 registers the content of a specified operation against parts constituting an object (the object part) as specified operation information in advance; the obtaining unit 12 obtains the specified operation information for identifying the specified operation that the object parts are caused to carry out; and the generating unit 13 generates a part animation of each of object parts, for which an operation is required, among the object parts of the object to control the specified operation of the object parts by dynamically calculating a rotation angle of a joint site required for the specified operation of the object parts in accordance with a predetermined calculation rule, and generates an animation of the entire object on the basis of the part animation of each of the object parts. Therefore, it becomes possible to reduce a load on a developer for generating an animation of an object while sufficiently ensuring the degree of freedom in designing the object.

Further, as one aspect of the first embodiment, the user terminal 20 that has functions to generate an animation of an object, which carries out an operation in a virtual space and is configured by a combination of parts that at least include one or more joint sites, is configured so as to at least include the registering unit 11, the obtaining unit 12, and the generating unit 13 (not illustrated in the drawings). Thus, the registering unit 11 registers the content of a specified operation against parts constituting an object (the object part) as specified operation information in advance; the obtaining unit 12 obtains the specified operation information for identifying the specified operation that the object parts are caused to carry out; and the generating unit 13 generates a part animation of each of object parts, for which an operation is required, among the object parts of the object to control the specified operation of the object parts by dynamically calculating a rotation angle of a joint site required for the specified operation of the object parts in accordance with a predetermined calculation rule, and generates an animation of the entire object on the basis of the part animation of each of the object parts. Therefore, it becomes possible to reduce a load on a developer for generating an animation of an object while sufficiently ensuring the degree of freedom in designing the object.

Namely, it becomes possible to dynamically generate the animation that the object is caused to carry out without using static animation data that are registered and managed as a set with a three-dimensional model in animation data in which a posture of an object and a rotation angle of each joint site are statically defined, that is, so-called assets. Therefore, it is not necessary to create static animation data in advance when an animation of an object is to be generated, and it is thus possible to reduce a load on a developer. This makes it possible to expect improvement in development speed of a video game, for example.

### Second Embodiment

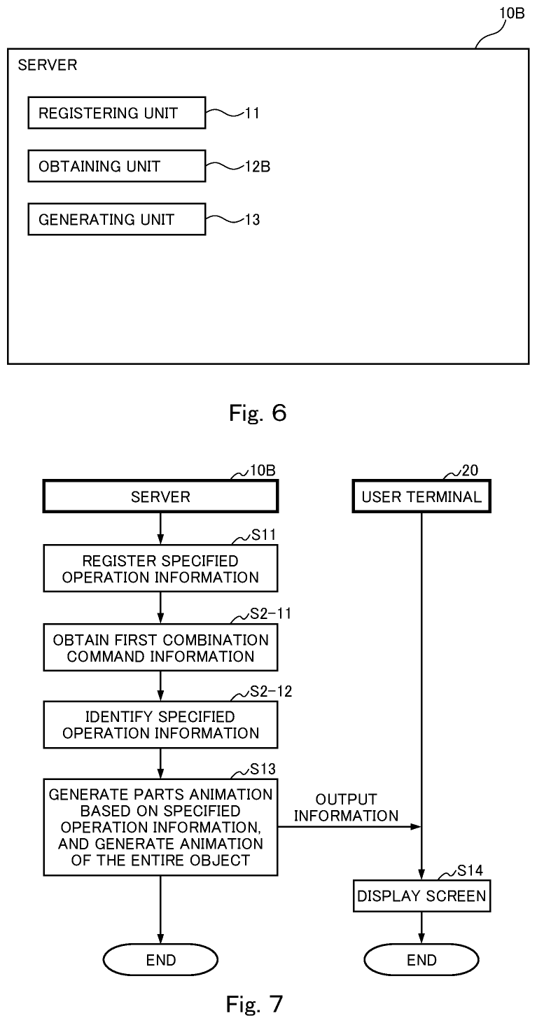

FIG. 6 is a block diagram illustrating a configuration of a server 10B, which is an example of the server 10. In the present embodiment, the server 10B at least includes a registering unit 11, an obtaining unit 12B, and a generating unit 13.

In the second embodiment, specified operation information obtained by the obtaining unit 12B is identified by first combination command information on a command obtained by combining specified operations for a plurality of object parts.

Here, the first combination command information means information on a command obtained by combining a plurality of specified operations for at least one or more object parts. The first combination command information may be information on a command obtained by combining specified operations for each of a plurality of different object parts, or may be information on a command obtained by combining a plurality of specified operations for one object part. The obtaining unit 12B identifies a plurality of specified operations contained in the first combination command information, selects and obtains specified operation information corresponding to each of the identified specified operations from those registered in advance.

FIG. 7 is a flowchart illustrating an example of an animation generating process executed by an animation generating system 100. Hereinafter, operations of the server 10B and a user terminal 20 (hereinafter, referred to as a “terminal 20”) will be described as an example. In this regard, a flowchart illustrating an operation of each of the server 10B and the terminal 20 is omitted from a point of view to avoid repeated explanation.

The server 10B obtains first combination command information (Step S2-11). Next, the server 10B identifies a plurality of specified operations contained in the first combination command information, selects and obtains specified operation information corresponding to each of the identified specified operations from those registered in advance (Step S2-12).

As explained above, as one aspect of the second embodiment, the server 10B that has functions to generate an animation of an object, which carries out an operation in a virtual space and is configured by a combination of parts that at least include one or more joint sites, is configured so as to at least include the registering unit 11, the obtaining unit 12B, and the generating unit 13. Thus, the specified operation information obtained by the obtaining unit 12B is identified by the first combination command information on a command obtained by combining specified operations for a plurality of object parts. Therefore, the first combination command information allows to combine and specify a plurality of specified operations for at least one object part. This makes it possible to express an animation of an object obtained by combining part animations by one piece of first combination command information.

### Third Embodiment

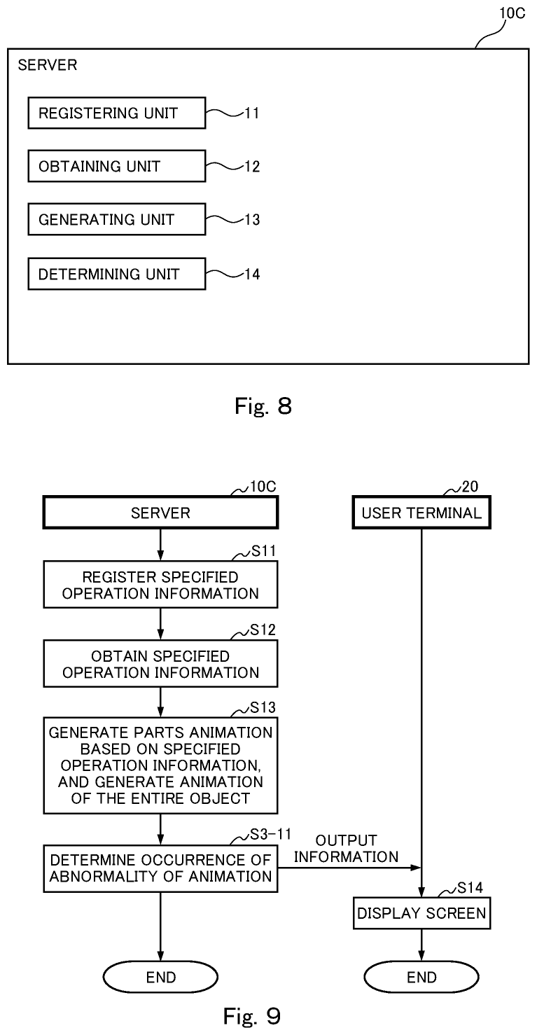

FIG. 8 is a block diagram illustrating a configuration of a server 10C, which is an example of the server 10. In the present embodiment, the server 10C at least includes a registering unit 11, an obtaining unit 12, a generating unit 13, and a determining unit 14.

The determining unit 14 has a function to determine occurrence of an abnormality in an animation on the basis of a state of at least one of a bone or a joint site included in an object in the animation generated by the generating unit 13.

Here, the bone is one of elements included by object parts, and means a skeleton part connecting joint sites. Two bones are connected by joint sites thereof. Each bone carries out rotational movement around a joint site thereof as a rotation angle of the joint site changes. With respect to generation of an animation of the object parts, for example, assuming that bones and skinning are set in advance, at least one of a position or a posture of a CG model associated with a bone changes in accordance with a change in at least one of a position or a posture of the bone during reproduction of an animation. A configuration to determine a state of each bone herein is not limited particularly. However, it is preferable that the configuration is based on a change in a position (or a coordinate) of a bone or a change in a posture (or an angle) of the bone. Further, a configuration to determine a state of a joint site is not limited particularly. However, it is preferable that the configuration is based on a change in a position (or a coordinate) of a joint site or a change in a rotation angle. As one example of conditions for determining occurrence of an abnormality, a configuration to determine whether an amount of change in a rotation angle or a position of at least one of a bone or a joint site is an amount of change that exceeds an expected range or not can be considered.

Further, the abnormality of the animation means that an operation of an object executed by animation data satisfies a condition to be determined as abnormal. As an example of the abnormality of the animation, it can be considered that a position or a rotation angle of at least one of a bone or a joint site exceeds a permissible range thereof.

Further, an animation that is a target for determining occurrence of an abnormality is not limited particularly. The target for determination may be a single part animation, or a combination of part animations. Here, the combination of part animations may be an animation of the entire object, or a combination of a plurality of part animations that is a part of the entire object.

FIG. 9 is a flowchart illustrating an example of an animation generating process executed by an animation generating system 100. Hereinafter, operations of the server 10C and a user terminal 20 (hereinafter, referred to as a “terminal 20”) will be described as an example. In this regard, a flowchart illustrating an operation of each of the server 10C and the terminal 20 is omitted from a point of view to avoid repeated explanation.

When an animation of the entire object is generated, the server 10C determines occurrence of an abnormality of the animation on the basis of a state of at least one of a bone or a joint site of an object in the generated animation (Step S3-11). For example, the server 10C determines occurrence of an abnormality of the animation by determining whether a position or a rotation angle of at least one of a bone or a joint site is within an expected range thereof or not.

As explained above, as one aspect of the third embodiment, the server 10C that has functions to generate an animation of an object, which carries out an operation in a virtual space and is configured by a combination of parts that at least include one or more joint sites, is configured so as to at least include the registering unit 11, the obtaining unit 12, the generating unit 13, and the determining unit 14. Thus, the determining unit 14 determines occurrence of an abnormality in an animation on the basis of a state of at least one of a bone or a joint site included in an object in the animation generated by the generating unit 13. Therefore, it becomes possible to easily determine whether there is an abnormality in a dynamically generated animation or not.

### Fourth Embodiment

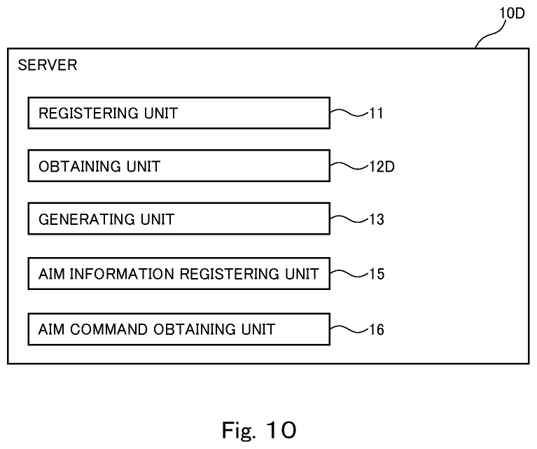

FIG. 10 is a block diagram illustrating a configuration of a server 10D, which is an example of the server 10. In the present embodiment, the server 10D at least includes a registering unit 11, an obtaining unit 12D, a generating unit 13, an aim information registering unit 15, and an aim command obtaining unit 16.

The aim information registering unit 15 has a function to register aim information for a plurality of posture states when each joint site included in the object is changed in various angles. A rotation angle of each joint site, a predetermined region of a predetermined object parts or a position of a part of an accompanying object that accompanies the object parts, and an aim direction are associated with each other in the aim information. The aim direction is a direction in which the predetermined region or a part of the accompanying object is aimed or faces.

Here, the phrase “each joint site is changed in various angles” means that a combination of rotation angles of joint sites is changed in various angles. Joint sites whose angles are to be changed are a part or all thereof. If rotation angles of the other joint sites of an object change even though rotation angles of a part of joint sites of the object do not change, it corresponds to a situation that each joint site is changed in various angles. In this regard, an amount of change in an angle of a joint site at the time of registration is not limited particularly. However, the joint site may be changed by a predetermined angle for each joint, that is, the joint site may be changed by 5°, for example.

Further, the accompanying object is an object that may be arranged in a virtual space so as to accompany an object part, and means an object whose position and/or posture changes so as to follow the object part. As the accompanying object, a weapon held by an object can be considered, for example. An accompanying object is not limited particularly so long as it accompanies an object part. However, it is preferable that at least one of a position or a posture of an accompanying object changes in substantially the same manner as at least one of a position or a posture of an object part changes.

Further, the aim direction herein means a direction in which a predetermined region or a part of an accompanying object is aimed in a posture state of an object at that time. As examples of the direction in which a predetermined region or a part of an accompanying object is aimed, a direction in which a lower arm of an object is aimed, a direction in which the muzzle of a rifle held by an object is aimed, and the like can be considered.

Further, the aim information means information for realizing an operation of causing a predetermined region of a predetermined object part or a part of an accompanying object that accompanies the object part to be directed to a specific direction. Specifically, the aim information is information in which a rotation angle of each joint site, a position of a predetermined region of a predetermined object part or a part of an accompanying object that accompanies the object part, and an aim direction that is a direction in which the predetermined region or a part of the accompanying object is aimed are associated with each other for a plurality of posture states when each joint site included in an object is changed in various angles. The aim information is not limited particularly so long as a posture of an object and an aim direction are associated with each other. Further, a plurality of posture states may be registered for the same aim direction.

Further, a configuration to register aim information is not limited particularly. Aim information may be registered in a predetermined storing unit included in the server 10D, or may be a storing unit included in a device (for example, the user terminal 20) capable of communicating with the server 10D.

The aim command obtaining unit 16 has a function to obtain an aim command to cause the predetermined region of the predetermined object parts or the part of the accompanying object that accompanies the object parts to aim in a specified aim direction.

The aim command is a command for requesting an object to carry out an operation of causing a predetermined region of an object part or a part of an accompanying object to aim in a specified aim direction. It can be considered that this aim command is issued by a user operation or is issued by AI that controls a character, which is one example of an object. The aim command includes a command to cause a predetermined region of an object part or a part of an accompanying object that accompanies the object part thus specified to aim in a specified aim direction.

The obtaining unit 12D has a function to obtain the aim information necessary for calculation on the basis of the aim direction specified by the aim command obtained by the aim command obtaining unit 16, and obtain the specified operation information necessary for executing the aim command on the basis of the obtained aim information.

Here, the phrase “obtain the aim information necessary for calculation” means that aim information corresponding to an aim direction is obtained by referring to the aim information, which has been registered by the aim information registering unit 15, by using information on an aim direction contained in an aim command.

Further, an aim direction in the aim information, which has been registered by the aim information registering unit 15, and an aim direction specified by the aim command do not always exactly match. Thus, in such a case, it is preferable that aim information on an aim direction that is the closest to the aim direction specified by the aim command is identified as an obtaining target. Alternatively, aim information on an aim direction specified by the aim command may be calculated approximately using plural kinds of registered aim information for close aim directions. When it is calculated approximately, it is preferable that a rotation angle of each joint site is also calculated approximately from a rotation angle of the joint site in each posture state in the plural kinds of registered aim information.

Further, the specified operation information necessary for executing the aim command means that in a case where an object is caused to carry out an operation so as to become a posture state registered in association with the aim direction in the aim information registered by the aim information registering unit 15 (or a posture state in the aim information calculated approximately using the plural kinds of registered aim information), at least specified operation information for specifying an operation necessary for each object part constituting the object.

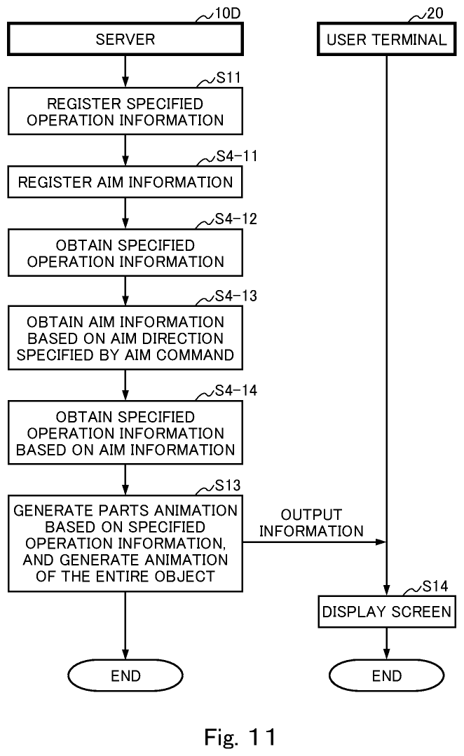

FIG. 11 is a flowchart illustrating an example of an animation generating process executed by an animation generating system 100. Hereinafter, operations of the server 10D and a user terminal 20 (hereinafter, referred to as a “terminal 20”) will be described as an example. In this regard, a flowchart illustrating an operation of each of the server 10D and the terminal 20 is omitted from a point of view to avoid repeated explanation.

The server 10D registers aim information for a plurality of posture states when each joint site included in the object is changed in various angles (Step S4-11). Here, a rotation angle of each joint site, a predetermined region of a predetermined object parts or a position of a part of an accompanying object that accompanies the object parts, and an aim direction are associated with each other in the aim information. Further, the aim direction is a direction in which the predetermined region or a part of the accompanying object is aimed.

The server 10D obtains an aim command to cause the predetermined region of the predetermined object parts or the part of the accompanying object that accompanies the object parts to aim in a specified aim direction (Step S4-12).

When the aim command is obtained, the server 10D obtains the aim information necessary for calculation on the basis of the aim direction specified by the obtained aim command (Step S4-13).

When the aim information is obtained, the server 10D obtains the specified operation information necessary for executing the aim command on the basis of the obtained aim information (Step S4-14).

As explained above, as one aspect of the fourth embodiment, the server 10D that has functions to generate an animation of an object, which carries out an operation in a virtual space and is configured by a combination of parts that at least include one or more joint sites, is configured so as to at least include the registering unit 11, the obtaining unit 12D, the generating unit 13, the aim information registering unit 15, and the aim command obtaining unit 16. Thus, the aim information registering unit 15 registers aim information for a plurality of posture states when each joint site included in the object is changed in various angles, a rotation angle of each joint site, a predetermined region of a predetermined object parts or a position of a part of an accompanying object that accompanies the object parts, and an aim direction being associated with each other in the aim information, the aim direction being a direction in which the predetermined region or a part of the accompanying object is aimed; the aim command obtaining unit 16 obtains an aim command to cause the predetermined region of the predetermined object parts or the part of the accompanying object that accompanies the object parts to aim in a specified aim direction; and the obtaining unit 12D obtains the aim information necessary for calculation on the basis of the aim direction specified by the aim command obtained by the aim command obtaining unit 16, and obtain the specified operation information necessary for executing the aim command on the basis of the obtained aim information. Therefore, it is possible to dynamically generate an animation for an aim command in various directions. In addition, by using the information registered in advance as the aim information, it becomes possible to reduce a processing load at the time of generation of the animation.

Further, it has not been mentioned particularly in the example of the fourth embodiment described above. However, in the process of obtaining the aim information by the obtaining unit 12D, a situation that aim information containing an aim direction substantially the same as an aim direction specified by an aim command is not registered, or a situation that it is impossible to cause a predetermined region of a predetermined object part or a part of an accompanying object to aim in an aim direction specified by an aim command due to range limitation of a rotation angle of a joint site of an object may occur. In such a case, the obtaining unit 12D may obtain aim information on an aim direction closest to the aim direction specified by the aim command, obtain specified operation information on the basis of the aim information, and further obtain specified operation information for causing the predetermined region or a part of the accompanying object to aim in a specified direction. Then, the generating unit 13 may cause the predetermined region or a part of the accompanying object to aim in the aim direction contained in the aim information on the basis of the obtained aim information and the obtained specified operation information, and generate an animation in which an object is caused to carry out a specified operation to aim from the aim direction to the aim direction specified by the aim command. By controlling them in this manner, it becomes possible to cause the object to carry out an aim command for a direction that is not included in the aim information.

### Fifth Embodiment

### [Generation of a Procedural Animation]

First, generation of a procedural animation will be described. In the present embodiment, in order to be capable of generating an animation dynamically and procedurally (controlled by mathematical formulas, scripts, condition definitions, and the like) for each object part constituting and object, the control content for each object part is calculated in accordance with specified operation information. Hereinafter, a concrete configuration will be described.

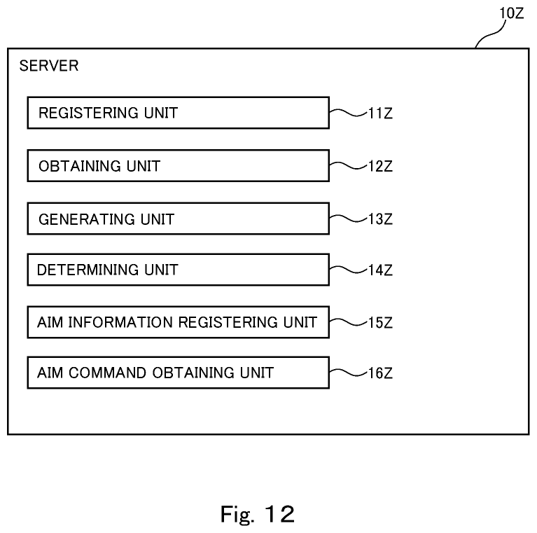

FIG. 12 is a block diagram illustrating a configuration of a server 10Z, which is an example of the server 10 in the animation generating system 100 (see FIG. 1). In the present embodiment, the server 10Z at least includes a registering unit 11Z, an obtaining unit 12Z, a generating unit 13Z, a determining unit 14Z, an aim information registering unit 15Z, and an aim command obtaining unit 16Z.

The registering unit 11Z has a function to register the content of a specified operation against parts constituting an object (hereinafter, referred to also as an “object part”) as specified operation information in advance.

Here, the object is a virtual object that may be arranged in a virtual space, and means an object configured by a combination of object parts that at least include one or more joint sites. In the present embodiment, the object is a humanoid character or a humanoid robot, for example.

Further, the object part means a predetermined region constituting an object. For example, in a case where an object is a humanoid character or a humanoid robot, the object is configured by a combination of object parts of a “head”, a “torso”, a “right arm”, a “right hand”, a “left arm”, a “left hand”, a “waist”, a “right leg”, a “right foot”, a “left leg” and a “left foot”.

Further, an operation of an object part means an operation in which at least one of a position or a posture of an object part changes. Further, the specified operation means an operation that the object part is caused to carry out. In the present embodiment, there is a corresponding specified operation for each object part of a humanoid character.

Further, the specified operation means an operation that an object part is caused to carry out. Further, the specified operation information means information for identifying the content of the specified operation. Moreover, information regarding conditions for dynamically calculating a rotation angle of the joint site to carry out the specified operation is contained in the specified operation information. The conditions are information indicating a target posture and a target direction, for example.

Further, information that the registering unit 11Z registers as the specified operation information may contain information on calculation rule for performing a specified operation by an object.

Here, the calculation rule may at least include a rule of dynamically calculating, in a case where a coordinate of a predetermined region of the object parts in a target posture or a direction in which the predetermined region is aimed is specified by the specified operation, a rotation angle of the joint site of the object parts for moving the predetermined region to a position of the specified coordinate or moving the predetermined region so as to aim in the specified direction. For example, the calculation rule may at least include a rule using 1K (Inverse Kinematics).

Further, the calculation rule may at least include a rule of calculating, in a case where information on a rotation angle of the joint site of the object parts in a target posture is specified by the specified operation, an amount of rotation of each of the joint sites until a target posture thereof is reached on the basis of the specified information on the rotation angle of the joint site. For example, the calculation rule may at least include a rule using FK (Forward Kinematics).

The IK and the FK are used properly in accordance with the content of an operation to be carried out by an object.

Further, the registering unit 11Z may be configured so that information on a mathematical function for causing an object to realize a specified operation is contained in the information registered as the specified operation information.

Here, the mathematical function for causing an object to realize a specified operation means a mathematical function of executing calculation about an operation that an object part is caused to carry out on the basis of an input of a predetermined type of parameter, and outputting information indicating a rotation angle of each joint site or a locus of each object part included in object parts. In the present embodiment, the mathematical function for causing an object to realize a specified operation is a mathematical function using the IK or the FK.

In this regard, the mathematical function for causing an object to realize a specified operation may be different from the specified operation information. Further, while the specified operation information contains information on a target posture, a target position, and a target direction of the specified operation, the mathematical function for causing an object to realize a specified operation may be different from the specified operation information. On the other hand, the information on a target posture, a target position, and a target direction of the specified operation may be contained in the mathematical function for causing an object to realize a specified operation.

In this regard, the content to be registered as the specified operation information may be any information so long as it is information that can be used to dynamically generate a part animation, and may be a data structure, a class, or the like in addition to the mathematical function.

Further, the calculation rule may be a rule of at least obtaining information on at least one of a position or a posture of the object parts for which an operation is required and information on surrounding environment of the object parts and executing calculation to dynamically carry out the specified operation on the basis of the obtained information.

Here, the information on surrounding environment of the object parts means information on situations around the object parts. The information on surrounding environment of the object parts is not limited particularly. However, it is preferable that the information is information that contains at least factors that can affect the process or a result of the specified operation in a case where object parts are caused to carry out a specified operation. As examples of the information on surrounding environment of the object parts, there are information indicating whether any object exists in the vicinity of the object parts, and information indicating a shape of the ground in a virtual space. In the present embodiment, the information on surrounding environment of the object parts is information on a landform in the vicinity of a place where a humanoid character is standing or information on objects arranged in the vicinity of the humanoid character.

The obtaining unit 12Z has a function to obtain the specified operation information for identifying the specified operation that the object parts are caused to carry out.

Here, a configuration to identify specified operation information that becomes an obtaining target is not limited particularly. The specified operation information may be identified by a user operation, or the specified operation information may be identified by AI for controlling a character that is one example of the object.

Further, the specified operation information obtained by the obtaining unit 12Z is identified by first combination command information on a command obtained by combining respective specified operations for a plurality of object parts. Hereinafter, the expression “animation clip” is used as a term to indicate the first combination command information according to the present embodiment. The animation clip is a command obtained by combining respective specified operations for a plurality of object parts or combining a plurality of specified operations for one object part.

Further, the specified operation information obtained by the obtaining unit 12Z is identified by second combination command information on a command obtained by further combining commands of plural kinds of first combination command information. Hereinafter, the expression “animation sequence” is used as a term to indicate the second combination command information according to the present embodiment. In a case where an animation is generated on the basis of an animation sequence, animation clips constituting an animation sequence are first identified, and a specified operation constituting each of the identified animation clips is identified. Then, the obtaining unit 12Z obtains specified operation information on the basis of the identified specified operations.

The generating unit 13Z has a function to generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on the basis of the part animation of each of the object parts.

Here, the predetermined calculation rule means a rule for dynamically calculating an operation that an object part is caused to carry out. Specifically, the predetermined calculation rule is a rule for executing various kinds of calculations so as to be an operation indicating a posture and a locus thus specified, and a direction when an object part is caused to carry out the operation.

Further, the object part for which an operation is required means an object part of the subject that carries out a specified operation identified by the specified operation information. In the present embodiment, object parts necessary for an operation are identified by the specified operation information obtained by the obtaining unit 12Z.

Further, the rotation angle of the joint site means that reference orientation of one object part of two object parts connected to a joint site with respect to the other object parts is expressed as a size of a rotation angle of the other object centered on the joint site. In the present embodiment, a value based on a default state of model data on a humanoid character is used for calculation of the rotation angle of the joint site.

Further, the phrase “dynamically calculate a rotation angle of a joint site” means that it is calculated in accordance with a situation of an object part having a joint site.

Further, the part animation means animation data of only an object part for controlling to cause the object part to carry out a specified operation. Further, an animation of the entire object is generated by combining part animations for a plurality of object parts.

Further, the generating unit 13Z may have a function to dynamically calculate a rotation angle of a joint site necessary for a specified operation of an object part by using a mathematical function as a calculation rule.

Here, the mathematical function used as the calculation rule is a mathematical function identified by information on the mathematical function for realizing the specified operation by the object contained in the specified operation information registered by the registering unit 11Z, for example.

Further, the generating unit 13Z may have a function to generate the part animation by determining, in a case where a command of start carrying out the other specified operation is given between start carrying out the specified operation for one object part of the object parts and end thereof, which specified operation of a plurality of the specified operations whose execution periods overlap with each other the one object part is caused to carry out on the basis of a predetermined priority order, and controlling the one object part to carry out the determined specified operation from a point of time of the overlap.

Here, the command of start carrying out the specified operation means a command of causing an object part to carry out a specified operation from a specified point of time. In the present embodiment, the specified point of time is a point of time of start carrying out appropriately specified for a specified operation by a part animation or a point of time of start carrying out identified by an animation clip or an animation sequence.

Further, the predetermined priority order means an order of specified operations that prioritize execution. The specified operation that prioritizes execution is not limited particularly. However, it is preferable that it is identified in advance on the basis of information set to the specified operation or determined at the time of generation of an animation. In the present embodiment, the predetermined priority order is an order in which execution is prioritized depending upon whether a specified operation whose execution period starts later is prioritized or not in a case where execution periods overlap. In the present embodiment, in a case where execution periods of a plurality of specified operations at least overlap (or compete against each other) partially, the specified operations are evaluated in the order according to the information set to each of the specified operations.

Further, the phrase “carry out the determined specified operation from a point of time of the overlap” means switching into execution of a determined specified operation from a point of time of overlap or continuing execution of a determined specified operation after a point of time of overlap. In this regard, in a case where specified operations that object parts are caused to carry out are switched at a point of time of overlap, two kinds of part animations may be blended during a switching period.

By configuring the generating unit 13Z in this manner, it becomes possible to cause an object to take more natural actions. The part animation is generated for each object part. For example, in case of a video game in which object parts of a robot object can be changed or customized in accordance with a user's request, by exchanging part animations regarding the object parts at the same time as exchanging the object parts, it becomes possible to generate an animation in accordance with customization. Further, in the above configuration, the control target for generation of the animation has been described as the rotation angle of the joint site, but it is not limited to this. By controlling movement and scaling of each object part, it becomes possible to increase variation of an animation. For example, it becomes possible to generate an animation of the expression that an arm of a robot is stretched.

Further, a method of generating a procedural animation according to the present embodiment has the greatest advantages in that it can address the environment, such as an animation in which a character lightly touches a wall while walking, and an animation in which a character adjusts a height of a foot thereof in accordance with undulation of the ground. In addition, it becomes possible to determine self-collision. For example, in a case where a robot whose parts can be exchanged is an object, a shape of the robot changes significantly due to the exchange of parts. However, since the self-collision can be determined at that time, it becomes possible to dynamically generate an animation. By determining the self-collision, it is possible to eliminate the inconsistency of an animation, and this makes it possible to improve the quality of the animation.

### [Detection of Abnormality of Animation]

By the above configuration, it is possible to generate an animation dynamically and procedurally. However, since procedural animations can be generated infinitely, it is difficult to visually confirm whether there is an abnormality in each of them or not. For this reason, it is preferable that the server 10Z is configured to automatically determine whether an abnormality occurs in a procedural animation or not.

Therefore, the determining unit 14Z may further be provided in the server 10Z, and determine occurrence of an abnormality of the generated animation on the basis of a state of at least one of a bone or a joint site of an object in the animation. Here, the bone is one of elements included by object parts, and means a skeleton part connecting joint sites. Two bones are connected by joint sites thereof. Each bone carries out rotational movement around a joint site thereof as a rotation angle of the joint site changes. Further, the abnormality of the animation means that an operation of an object executed by animation data satisfies a condition to be determined as abnormal. As an example of the abnormality of the animation, it can be considered that a position or a rotation angle of at least one of a bone or a joint site exceeds a permissible range thereof.

Further, the server 10Z as the determining unit 14Z may be configured to determine that abnormality occurs in a case where a difference between rotation angles of at least one of the bone or the joint site at two points of time in a predetermined time interval in the animation generated by the generating function exceeds a predetermined threshold value. For example, the two points of time in the predetermined time interval are two frames while carrying out a predetermined operation or two important pause points of time in the predetermined operation. By determining whether an amount of change in an angle within a certain period of time is too large or not by such a configuration, it becomes possible to determine, as an abnormality, an animation in which a position of a bone instantaneously moves while lacking continuity.

Further, the server 10Z as the determining unit 14Z may be configured to determine that abnormality in rotation of the bone occurs in a case where a rotation angle of at least one of the bone or the joint site in the animation generated by the generating function exceeds an angle within a predetermined range. Here, the angle within the predetermined range can appropriately be set for at least one of the bone or the joint site. By configuring the server 10Z in this manner, it becomes possible to determine, as an abnormality, an animation in which a position of a bone or a rotation angle of a joint site moves beyond a permissible range thereof.

Further, the server 10Z as a storing unit (not illustrated in the drawings) may be configured to store the specified operation information or a combination of a plurality of specified operations used to generate an animation satisfying a predetermined standard of the part animation or the animation of the entire object in a predetermined storing unit. Here, the predetermined standard is not limited particularly. However, a standard that an abnormality of an animation occurs can be considered. Information stored in the predetermined storing unit by the storing unit is not limited particularly so long as an animation that satisfies the predetermined standard can be reproduced. In the present embodiment, information stored in the storing unit is the specified operation information, the first combination command information, the second combination command information, and the like. Namely, by storing the specified operation information (containing information on a combination of a plurality of specified operation) used for generating an animation in the predetermined storing unit by the storing unit, it is possible to reproduce any level of animation such as the part animation, the animation clip, and the animation sequence. By configuring the server 10Z in this manner, it becomes possible for a creator to easily confirm the content of an animation that satisfies the predetermined standard, and improvement in development efficiency can be expected. Namely, for procedural animations that can be generated indefinitely, it is difficult to later reproduce an animation in which a problem occurred. Thus, there is a problem to how to debag. However, if the animation in which an abnormality occurs can be stored, it becomes possible to construct accumulated information on conditions when an abnormality occurs. As a result, it is possible to obtain an effect that the conditions when an abnormality occurs can be avoided although it is a procedural animation.

By allowing to determine the occurrence of an abnormality of an animation generated dynamically on the basis of the state of at least one of the bone or the joint site of the object in this manner, it becomes possible to automatically determine an abnormality of the procedural animation that can be generated indefinitely, and this makes it possible to secure the quality of the generated animation.

### [Animation Generation Regarding Aim Operation]

By dynamically calculating a part animation of each object part on the basis of the specified operation information, it becomes possible to generate an animation dynamically and procedurally. However, there is no method of carry out an aim operation in a specific direction at any angle for so-called aim operation such as an operation to cause a part of parts of an object to be directed to (or aim) a target, or an operation to cause the muzzle of a gun held by an object to aim toward a target.

Therefore, the aim information registering unit 15Z may further be provided in the server 10Z, and register aim information for a plurality of posture states when each joint site included in the object is changed in various angles. In this case, a rotation angle of each joint site, a predetermined region of a predetermined object parts or a position of a part of an accompanying object that accompanies the object parts, and an aim direction are associated with each other in the aim information. Further, the aim direction is a direction in which the predetermined region or a part of the accompanying object is aimed.

Here, the phrase “each joint site is changed in various angles” means that a combination of rotation angles of joint sites is changed in various angles. Joint sites whose angles are to be changed are a part or all thereof. If rotation angles of the other joint sites of an object change even though rotation angles of a part of joint sites of the object do not change, it corresponds to a situation that each joint site is changed in various angles. In this regard, an amount of change in an angle of a joint site at the time of registration is not limited particularly. However, the joint site may be changed by a predetermined angle for each joint, that is, the joint site may be changed by 5°, for example.

Further, the accompanying object is an object that may be arranged in a virtual space so as to accompany an object part, and means an object whose position and/or posture changes so as to follow the object part. In the present embodiment, the accompanying object corresponds to a gun held by a humanoid character by hand thereof, for example.

Further, the aim direction according to the present embodiment means a direction in which a predetermined region or a part of an accompanying object is aimed in a posture state of an object at that time. As examples of the direction in which a predetermined region or a part of an accompanying object is aimed, a direction in which a lower arm of an object is aimed, a direction in which the muzzle of a rifle held by an object is aimed, and the like can be considered.

Further, the aim information means information for realizing an operation of causing a predetermined region of a predetermined object part or a part of an accompanying object that accompanies the object part to aim in a specific direction. In the present embodiment, for example, the aim information corresponds to information in which a rotation angle of each joint site, a position of the muzzle of a gun held by a humanoid character by hand thereof, and an aim direction that is a direction in which the muzzle is aimed are associated with each other for a plurality of posture states when each joint site included in the humanoid character is changed in various angles.

Further, the aim command obtaining unit 16Z may further be provided in the server 10Z, and obtain an aim command to cause the predetermined region of the predetermined object parts or the part of the accompanying object that accompanies the object parts to aim in a specified aim direction. The aim command is a command for requesting an object to carry out an operation of causing a predetermined region of an object part or a part of an accompanying object to aim in a specified aim direction. It can be considered that this aim command is issued by a user operation or is issued by AI that controls a character, which is one example of an object. The aim command includes a command to cause a predetermined region of an object part or a part of an accompanying object that accompanies the object part thus specified to aim in a specified aim direction.

In the present embodiment, the specified aim direction means a direction when a specified target is aimed. In the present embodiment, the specified aim direction is a direction in which the muzzle of the gun held by the humanoid character by hand thereof is aimed toward a specific target.

Further, the obtaining unit 12Z may obtain the aim information necessary for calculation on the basis of the aim direction specified by the obtained aim command, and obtain the specified operation information necessary for executing the aim command on the basis of the obtained aim information.

Here, the phrase “obtain the aim information necessary for calculation” means that aim information corresponding to an aim direction is obtained by referring to the aim information, which has been registered by the aim information registering unit 15Z, by using information on an aim direction contained in an aim command. In the present embodiment, for example, the obtaining unit 12Z identifies aim information on an aim direction, which matches or is closest to the specified aim direction, as an obtaining target.

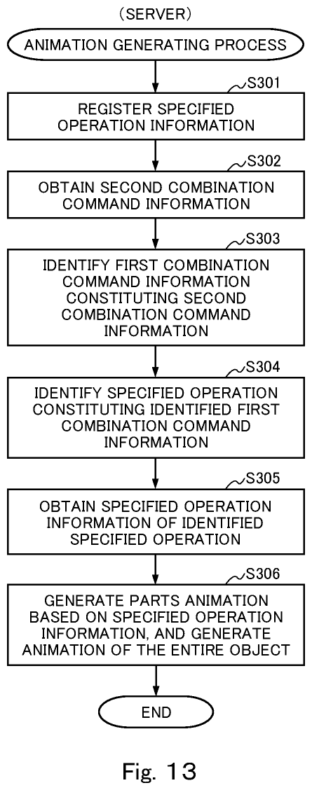

FIG. 13 is a flowchart illustrating an example of an animation generating process executed by the server 10Z. In the animation generating process according to the present embodiment, processes related to a control of generation of an animation are executed. Hereinafter, each of the processes will be described. In this regard, the order of the processes may be changed without any contradiction or the like of processing content.

The animation generating process is started, for example, when the terminal 20 that has accessed the server 10Z requests start of processes regarding generation of an animation.

In the animation generating process, the server 10Z first registers the content of a specified operation against parts constituting an object (hereinafter, referred to also as an “object part”) as specified operation information in advance (Step S301). In the present embodiment, the server 10Z registers, as the specified operation information, information indicating that which object part it is and information regarding a condition for dynamically calculating a rotation angle of a joint site for causing an object part of a humanoid character to carry out the specified operation so as to be associated with each other.

When the content of the specified operation is registered in advance as the specified operation information, the server 10Z obtains second combination command information (Step S302). In the present embodiment, the server 10Z obtains the second combination command information when a command to execute an animation sequence is made or issued.

When the second combination command information is obtained, the server 10Z identifies first combination command information constituting the obtained second combination command information (Step S303). In the present embodiment, in order to identify the content of an animation clip constituting the animation sequence, the server 10Z identifies first combination command information on the basis of information for identifying the first combination command information contained in the obtained second combination command information.

When the first combination command information is identified, the server 10Z identifies a specified operation constituting the identified first combination command information (Step S304). In the present embodiment, in order to generate a part animation constituting the animation clip, the server 10Z identifies the specified operation on the basis of information for identifying the specified operation information contained in the identified first combination command information as an obtaining target.

When the specified operation is identified, the server 10Z obtains the specified operation information of the identified specified operation (Step S305). In the present embodiment, the server 10Z selects and obtains the identified one from the registered specified operation information as the obtaining target.

When the specified operation information is obtained, the server 10Z generates a part animation on the basis of the obtained specified operation information, and generates an animation of the entire object on the basis of part animations of the respective object parts (Step S306). In the present embodiment, the server 10Z generates part animations on the basis of the information indicating that which object part it is and the information regarding the condition for dynamically calculating the rotation angle of the joint site for causing the object part of the humanoid character to carry out the specified operation, and generates an animation clip by combining the generated part animations. Then, the server 10Z generates an animation sequence by combining the animation clips.

In the present embodiment, when an animation of the entire object is generated, the server 10Z terminates the processes herein.

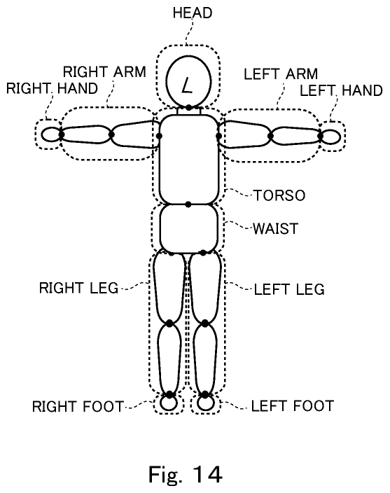

FIG. 14 is an explanatory drawing for explaining an example of object parts corresponding to at least one of the embodiments of the present disclosure. FIG. 14 illustrates a humanoid character that is one example of an object. The humanoid character illustrated in FIG. 14 is configured by a total of 11 object parts of a “head”, a “torso”, a “right arm”, a “right hand”, a “left arm”, a “left hand”, a “waist”, a “right leg”, a “right foot”, a “left leg” and a “left foot”. Further, these object parts are respectively connected to each other by joint sites. Namely, two adjacent object parts are connected to each other using a joint site as a boundary. A joint site positioned at a boundary of two object parts is treated as belonging to any one object part. For example, a joint site of a boundary between the “torso” and the “right arm” belongs to the “right arm”. Further, for example, a joint site of a boundary between the “head” and the “torso” belongs to the “head”. In this regard, a joint site may be provided in an object part in addition to the boundaries of the object parts. For example, the “right arm” includes one joint site at a position of the middle elbow.

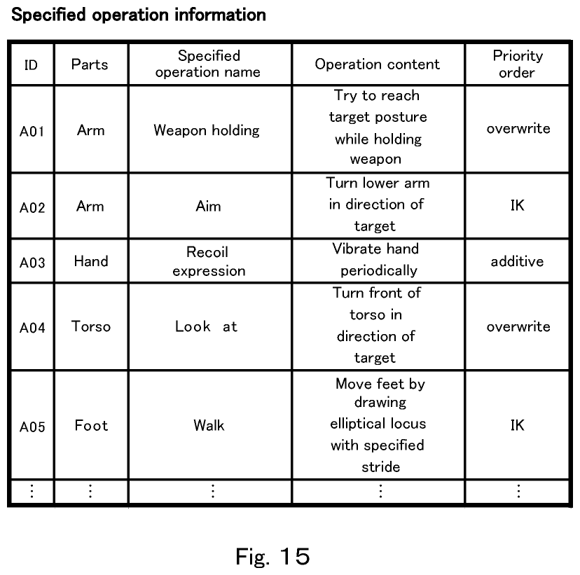

FIG. 15 is an explanatory drawing for explaining an example of specified operation information corresponding to at least one of the embodiments of the present disclosure. FIG. 15 illustrates one example of the specified operation information registered by the registering unit 11Z.

Here, an “ID” is information for identifying a type of specified operation.

Further, “parts” are information indicating which object part a specified operation is. In the present embodiment, the “parts” indicate which object part a specified operation is without distinguishing between left and right.

Further, a “specified operation name” is a name of a specified operation corresponding to an “ID”. In the present embodiment, a name by which an overview of a specified operation is seen, such as “weapon holding” or “aim”, is shown as the “specified operation name”. As described above, some specified operations can be used in various situations. On the other hand, a specified operation name whose ID is “A03” is “recoil expression”. The “recoil expression” is a specified operation that expresses recoil when firing with a gun held by a character. In this manner, there may be a specified operation whose use situation is limited.

Further, the “operation content” is the content of a concrete operation of an object part for carrying out a specified operation. In the present embodiment, the “operation content” is information indicating an overview of a concrete action of an object part. For each specified operation, calculation of a rotation angle of a joint site is executed in accordance with the “operation content” by using IK or FK. In this regard, a specified operation of “walk” whose part is “foot” is an operation with periodicity in which calculation is executed with a specific locus as a target and a part animation is generated.

Further, a “priority order” is information that determines which specified operation one object part is caused to carry out in a case where execution of a plurality of specified operations is overlapped for the one object part. In the present embodiment, any of three types of “overwrite”, “IK”, and “additive” is associated with a specified operation as the information that determines the priority order.

The specified operation of the “overwrite” is an operation to overwrite a specified operation whose execution period has already started. Specifically, in a case where an execution period of a specified operation whose priority order is “overwrite” starts for one object part, the specified operation is carried out with priority. In this regard, the “overwrite” is set to an operation in which an animation is generated by calculation using the FK.

The specified operation of the “IK” is prioritized over the specified operation of the “overwrite”. Specifically, in a case where an execution period of a specified operation whose priority order is the “IK” starts for one object part, the specified operation of the “IK” is carried out with priority even though the execution period of the “overwrite” has started. In this regard, the “IK” is set to an operation in which an animation is generated by calculation using the IK.

The specified operation of the “additive” is an operation to execute addition processing on a control state of a posture at that point of time. Specifically, in a case where execution of the specified operation of the “additive” is started during the execution period of the specified operation of the “overwrite” or the “IK”, it is carried out so that the specified operation of “additive” is added based on a state during execution of the specified operation of the “overwrite” or the “IK”.

In this regard, in a case where at least a part of execution periods of a plurality of specified operations overlaps (or competes against each other), part animations of the specified operations are evaluated in the order of the “overwrite”, the “IK”, and the “additive”, the above process regarding the priority order is executed.

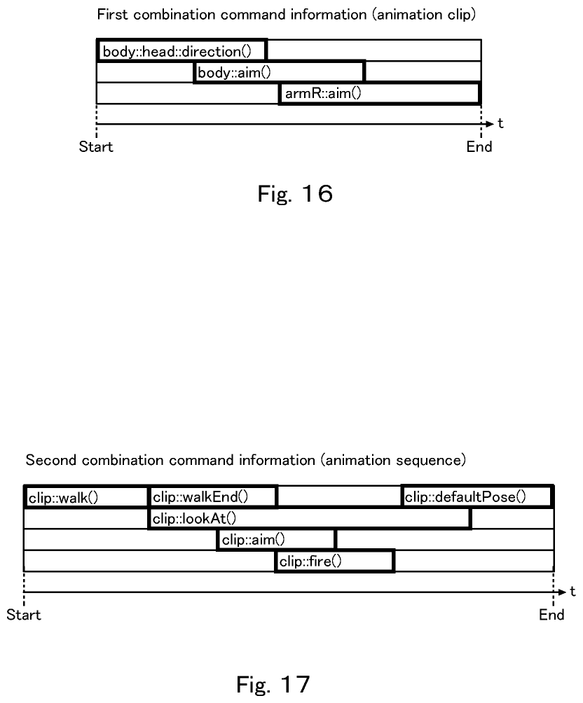

FIG. 16 is an explanatory drawing illustrating an example of first combination command information corresponding to at least one of the embodiments of the present disclosure. FIG. 16 illustrates the content of first combination command information (an animation clip). As illustrated in FIG. 16, the first combination command information is information indicating a combination of a plurality of specified operations, and specified operation information identifying each specified operation is information of a mathematical function for realizing the specified operation by an object. Here, for each specified operation, it is possible to specify execution start timing, an execution time length, operation progress speed with respect to an execution period length, and the like. Here, the specified operation is executed slowly as the execution period becomes longer, and the specified operation is executed fast as the execution period becomes shorter. The specified operations in which the target object parts are different from each other and the execution periods partially overlap are carried out at the same time. Further, the operation progress speed with respect to the execution period length is the speed of the execution progress of the specified operation with respect to the execution period length. In this regard, in the example illustrated in FIG. 16, a period from a point of time when the execution is first started to a point of time when the execution is finally ended of the plurality of specified operations is an execution period of the animation clip. In the example of FIG. 16, by sequentially executing, by the animation clip, operations including: a specified operation of causing a torso (body) and a head (head) to be directed to a predetermined direction is executed by a mathematical function called direction( ) a specified operation of causing a torso (body) to aim in a predetermined direction is executed by a mathematical function called aim( ) and a specified operation of causing a right arm (armR) to aim in a predetermined direction is executed by a mathematical function called aim( ) it becomes possible to dynamically generate an animation of a series of operations of “a head and a torso are directed to a predetermined direction to find a target object, and the torso and a right arm are caused to sequentially aim the target object to aim the muzzle at the target object”.

FIG. 17 is an explanatory drawing illustrating an example of second combination command information corresponding to at least one of the embodiments of the present disclosure. FIG. 17 illustrates the content of a second combination command information (animation sequence). As illustrated in FIG. 17, the second combination command information is a command obtained by further combining plural kinds of first combination command information. As well as the animation clip, the animation sequence can specify execution start timing or an execution period of each animation clip. Here, the animation clip is executed slowly as the execution period becomes longer, and the animation clip is executed fast as the execution period becomes shorter. In this regard, in the example illustrated in FIG. 17, a period from a point of time when the execution is first started to a point of time when the execution is finally ended of the plurality of animation clips is an execution period of the animation sequence. In the present embodiment, the animation sequence is stored in a queue by a FIFO (First In First Out) method, and is sequentially executed. In this regard, in a case where a predetermined interrupt condition is satisfied, a new animation sequence is added to a location other than the end of the queue. According to the animation sequence, it becomes possible to dynamically generate an animation for carrying out a more complex operation by combining animation clips.

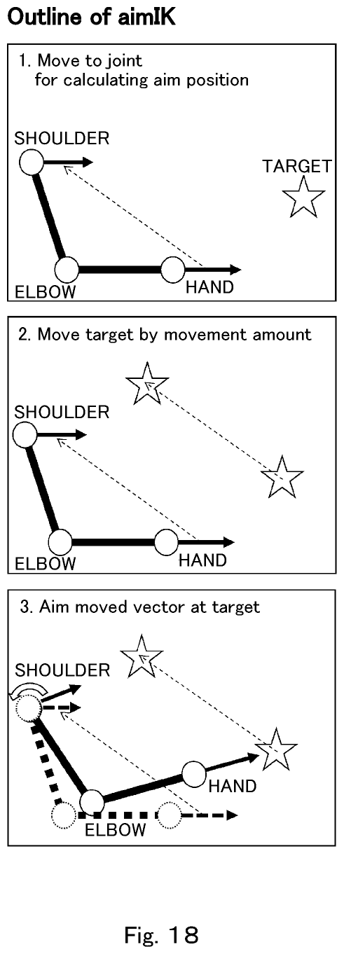

FIG. 18 is an explanatory drawing illustrating an example of “aimIK” for performing an aim operation corresponding to at least one of the embodiments of the present disclosure. The aimIK is a method that is newly developed in order to dynamically perform a process of causing orientation of a part of an object of a part of an accompanying object of the object to aim a target. For example, in order to perform the process of “causing a direction of an arm to be directed to the target”, in a case where a rotation of a joint site of a shoulder is indispensable, in the aimIK, information on an aim direction set to the tip of a hand (vector indicating the aim direction) is first moved to the joint site of the shoulder. Next, a virtual target is arranged by also moving a target as much as movement of the vector indicating the aim direction. Then, the joint site of the shoulder is rotated so that the direction of the vector moved to the joint site of the shoulder faces the virtual target. When it becomes a state where the vector direction of the joint site of the shoulder is oriented toward the virtual target by such a procedure, it becomes a state where an aim direction of a hand is also oriented toward an original target. In this regard, in case of a plane space illustrated in FIG. 18, the aim is completed by one process. However, since it is actually a three-dimensional object in a three-dimensional space and the axis of rotation differs depending upon each joint site, there is a fact that it is not possible to aim accurately with a single process. Therefore, in a case where the aimIK is actually executed, the process is repeated for each joint site so that orientation of a part of the object and a part of the accompanying object of the object gradually faces the aim direction. In such an aim operation by the aimIK, in a case where the aim direction in the aim information registered in the aim information registering unit 15Z and the aim direction specified by the aim command do not match completely, a posture control is executed up to a close posture state on the basis of the approximate aim information, and the aim operation is realized by the aimIK from that state until the aim direction completely matches the aim direction specified by the aim command, whereby it becomes possible to always realize the aim operation of accurately aligning orientation with respect to the aim direction specified by the aim command while avoiding a situation that an action exceeding the limit of the rotation angle of the joint site (that is, a movable range of a joint) occurs.

As explained above, as one aspect of the fifth embodiment, the server 10Z that has functions to generate an animation of an object, which carries out an operation in a virtual space and is configured by a combination of parts that at least include one or more joint sites, is configured so as to at least include the registering unit 11Z, the obtaining unit 12Z, and the generating unit 13Z. Thus, the registering unit 11Z registers the content of a specified operation against parts constituting an object (hereinafter, referred to also as an “object part”) as specified operation information in advance; the obtaining unit 12Z obtains the specified operation information for identifying the specified operation that the object parts are caused to carry out; and the generating unit 13Z generates a part animation of each of object parts, for which an operation is required, among the object parts of the object to control the specified operation of the object parts by dynamically calculating a rotation angle of a joint site required for the specified operation of the object parts in accordance with a predetermined calculation rule, and generates an animation of the entire object on the basis of the part animation of each of the object parts. Therefore, it becomes possible to reduce a load on a developer for generating an animation of an object while sufficiently ensuring the degree of freedom in designing the object.

Namely, the animation of the object is dynamically generated without using animation data (assets) in which a posture of an object and a rotation angle of each joint site are statically defined. Therefore, it is not necessary to create static animation data in advance when an animation of an object is to be generated, and it is thus possible to reduce a load on a developer. This makes it possible to expect improvement in development speed of a video game, for example. In addition, since animation data are not used, it becomes possible to avoid restrictions on the design of the object from the data.

Further, in the example of the fifth embodiment described above, the specified operation information obtained by the obtaining unit 12Z is identified by the first combination command information (the animation clip) on the command obtained by combining specified operations for the plurality of object parts. Therefore, it becomes possible to express the action of the object that bundles a plurality of part animations as the command information.

Further, in the example of the fifth embodiment described above, the determining unit 14Z determines occurrence of an abnormality in the animation on the basis of a state of at least one of a bone or a joint site included in the object in the animation generated by the generating unit 13Z, whereby an animation is dynamically generated. Therefore, even in a case where a developer himself or herself cannot confirm presence or absence of an abnormality of an animation in advance, it becomes possible to detect an abnormality of an animation.

Further, in the example of the fifth embodiment described above, the aim information registering unit 15Z registers aim information for a plurality of posture states when each joint site included in the object is changed in various angles, a rotation angle of each joint site, a predetermined region of a predetermined object parts or a position of a part of an accompanying object that accompanies the object parts, and an aim direction being associated with each other in the aim information, the aim direction being a direction in which the predetermined region or a part of the accompanying object is aimed; the aim command obtaining unit 16Z obtains an aim command to cause the predetermined region of the predetermined object parts or the part of the accompanying object that accompanies the object parts to aim in a specified aim direction; and the obtaining unit 12Z obtains the aim information necessary for calculation on the basis of the aim direction specified by the aim command obtained by the aim command obtaining unit 16Z, and obtain the specified operation information necessary for executing the aim command on the basis of the obtained aim information. the aim information registering unit 15 registers aim information for a plurality of posture states when each joint site included in the object is changed in various angles, a rotation angle of each joint site, a predetermined region of a predetermined object parts or a position of a part of an accompanying object that accompanies the object parts, and an aim direction being associated with each other in the aim information, the aim direction being a direction in which the predetermined region or a part of the accompanying object is aimed; the aim command obtaining unit 16 obtains an aim command to cause the predetermined region of the predetermined object parts or the part of the accompanying object that accompanies the object parts to aim in a specified aim direction; and the obtaining unit 12D obtains the aim information necessary for calculation on the basis of the aim direction specified by the aim command obtained by the aim command obtaining unit 16, and obtain the specified operation information necessary for executing the aim command on the basis of the obtained aim information. Therefore, it becomes possible to dynamically execute the aim command in various directions without using static animation data that specifies a posture of an object in the process of execution of an operation and a rotation angle of each joint site.

As explained above, one shortage or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, and 201 to 20N and the server 10 executes the various kinds of processing described above in accordance with various kinds of control programs (for example, an animation generating program) stored in the storage device with which the corresponding terminal or server is provided.

Further, the configuration of the animation generating system 100 is not limited to the configuration that has been explained as an example of each of the embodiments described above. For example, the system 100 may be configured so that the server 10 executes a part or all of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a part or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that the program causes a single apparatus to perform a part or all of the functions that have been explained as the example of each of the embodiments described above without including a communication network.

(Appendix)

(1)
A non-transitory computer-readable medium storing an animation generating program for causing a server to perform functions to generate an animation of an object, the object carrying out an operation in a virtual space, the object being configured by a combination of parts, the parts at least including one or more joint sites, the functions comprising:
registering content of a specified operation against the parts constituting the object as specified operation information in advance, each of the parts constituting the object being an object part;
obtaining the specified operation information for identifying the specified operation, the object parts being caused to carry out the specified operation; and
generating a part animation of each of object parts, for which an operation is required, among the object parts of the object to control the specified operation of the object parts by dynamically calculating a rotation angle of a joint site required for the specified operation of the object parts in accordance with a predetermined calculation rule, and generating an animation of the entire object on a basis of the part animation of each of the object parts.
(2)
The non-transitory computer-readable medium according to (1),
wherein the specified operation information obtained by the obtaining is identified by first combination command information on a command obtained by combining the specified operations for a plurality of the object parts.
(2-1)
The non-transitory computer-readable medium according to (2),
wherein the specified operation information obtained by the obtaining is identified by second combination command information on a command obtained by further combining commands in plural kinds of the first combination command information.
(3)
The non-transitory computer-readable medium according to (1) or (2),
wherein in the registering, information to be registered as the specified operation information contains information on mathematical function for performing the specified operation by the object, an
wherein the generating includes dynamically calculating the rotation angle of the joint site required for the specified operation of the object parts by using the mathematical function as the calculation rule.
(4)
The non-transitory computer-readable medium according to any one of (1) to (3),
wherein the calculation rule is a rule of at least obtaining information on at least one of a position or a posture of the object parts for which an operation is required and information on surrounding environment of the object parts and executing calculation to dynamically carry out the specified operation on a basis of the obtained information.
(5)
The non-transitory computer-readable medium according to any one of (1) to (4),
wherein the generating includes generating the part animation by determining, in a case where a command of start carrying out the other specified operation is given between start carrying out the specified operation for one object part of the object parts and end thereof, which specified operation of a plurality of the specified operations whose execution periods overlap with each other the one object part is caused to carry out on a basis of a predetermined priority order, and controlling the one object part to carry out the determined specified operation from a point of time of the overlap.
(6)
The non-transitory computer-readable medium according to any one of (1) to (5),
wherein the calculation rule at least includes a rule of calculating, in a case where a coordinate of a predetermined region of the object parts in a target posture or a direction in which the predetermined region is aimed is specified by the specified operation, a rotation angle of the joint site of the object parts for moving the predetermined region to a position of the specified coordinate or moving the predetermined region so as to aim in the specified direction.
(7)
The non-transitory computer-readable medium according to any one of (1) to (6),
wherein the calculation rule at least includes a rule of calculating, in a case where information on a rotation angle of the joint site of the object parts in a target posture is specified by the specified operation, an amount of rotation of each of the joint sites until a target posture thereof is reached on a basis of the specified information on the rotation angle of the joint site.
(8)
The non-transitory computer-readable medium according to any one of (1) to (7), the functions further comprising:
a determining occurrence of abnormality in the animation on a basis of a state of at least one of a bone or the joint site included in the object in the animation generated by the generating.
(8-1)
The non-transitory computer-readable medium according to (8),
wherein the determining includes determining that abnormality occurs in a case where a difference between rotation angles of at least one of the bone or the joint site at two points of time in a predetermined time interval in the animation generated by the generating exceeds a predetermined threshold value.
(8-2)
The non-transitory computer-readable medium according to (8) or (8-1),
wherein the determining includes determining that abnormality in rotation of the bone occurs in a case where a rotation angle of at least one of the bone or the joint site in the animation generated by the generating exceeds an angle within a predetermined range.
(9)
The non-transitory computer-readable medium according to any one of (1) to (8), the functions further comprising:
storing the specified operation information or a combination of a plurality of the specified operations used to generate an animation satisfying a predetermined standard of the part animation or the animation of the entire object in a predetermined storing unit.
(10)
The non-transitory computer-readable medium according to any one of (1) to (9), the functions further comprising:
registering aim information for a plurality of posture states when each joint site included in the object is changed in various angles, a rotation angle of each joint site, a predetermined region of a predetermined object parts or a position of a part of an accompanying object that accompanies the object parts, and an aim direction being associated with each other in the aim information, the aim direction being a direction in which the predetermined region or a part of the accompanying object is aimed; and
obtaining an aim command to cause the predetermined region or the part of the accompanying object to aim in a specified aim direction,
wherein the obtaining includes obtaining the aim information necessary for calculation on a basis of the aim direction specified by the obtained aim command, and obtaining the specified operation information necessary for executing the aim command on a basis of the obtained aim information.
(11)
A non-transitory computer-readable medium storing an animation generating program for causing a user terminal to perform at least one function of the functions that the animation generating program described in any one of (1) to (10) causes the server to perform, the user terminal being capable of communicating with the server.
(12)
An animation generating system for generating an animation of an object, the object carrying out an operation in a virtual space, the object being configured by a combination of parts, the parts at least including one or more joint sites, the animation generating system comprising a communication network, a server, and a user terminal, one or more processors configured to:
register content of a specified operation against the parts constituting the object as specified operation information in advance, each of the parts constituting the object being an object part;
obtain the specified operation information for identifying the specified operation, the object parts being caused to carry out the specified operation; and
generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on a basis of the part animation of each of the object parts.
(13)
The animation generating system according to (12)
the processors in the server configured to:
register content of a specified operation against the parts constituting the object as specified operation information in advance, each of the parts constituting the object being an object part;
obtain the specified operation information for identifying the specified operation, the object parts being caused to carry out the specified operation; and
generate a part animation of each of object parts, for which an operation is required, among the object parts of the object to control the specified operation of the object parts by dynamically calculating a rotation angle of a joint site required for the specified operation of the object parts in accordance with a predetermined calculation rule, and generate an animation of the entire object on a basis of the part animation of each of the object parts, and
the processors in the user terminal configured to output controller configured to output a screen to a display screen of a display device, the screen indicating a state of the predetermined object.
(14)
A non-transitory computer-readable medium storing an animation generating program for causing a user terminal to perform functions to generate an animation of an object, the object carrying out an operation in a virtual space, the object being configured by a combination of parts, the parts at least including one or more joint sites, the functions comprising:
registering content of a specified operation against the parts constituting the object as specified operation information in advance, each of the parts constituting the object being an object part;
obtaining the specified operation information for identifying the specified operation, the object parts being caused to carry out the specified operation; and
generating a part animation of each of object parts, for which an operation is required, among the object parts of the object to control the specified operation of the object parts by dynamically calculating a rotation angle of a joint site required for the specified operation of the object parts in accordance with a predetermined calculation rule, and generating an animation of the entire object on a basis of the part animation of each of the object parts.
(15)
An animation generating method of generating an animation of an object, the object carrying out an operation in a virtual space, the object being configured by a combination of parts, the parts at least including one or more joint sites, the animation generating method comprising:
a registering processing for registering content of a specified operation against the parts constituting the object as specified operation information in advance, each of the parts constituting the object being an object part;
an obtaining processing for obtaining the specified operation information for identifying the specified operation, the object parts being caused to carry out the specified operation; and
a generating processing for generating a part animation of each of object parts, for which an operation is required, among the object parts of the object to control the specified operation of the object parts by dynamically calculating a rotation angle of a joint site required for the specified operation of the object parts in accordance with a predetermined calculation rule, and generating an animation of the entire object on a basis of the part animation of each of the object parts.
(16)
An animation generating method of generating an animation of an object by an animation generating system, the object carrying out an operation in a virtual space, the object being configured by a combination of parts, the parts at least including one or more joint sites, the animation generating system comprising a communication network, a server, and a user terminal, the animation generating method comprising:
a registering processing for registering content of a specified operation against the parts constituting the object as specified operation information in advance, each of the parts constituting the object being object part;
an obtaining processing for obtaining the specified operation information for identifying the specified operation, the object parts being caused to carry out the specified operation; and
a generating processing for generating a part animation of each of object parts, for which an operation is required, among the object parts of the object to control the specified operation of the object parts by dynamically calculating a rotation angle of a joint site required for the specified operation of the object parts in accordance with a predetermined calculation rule, and generating an animation of the entire object on a basis of the part animation of each of the object parts.

### INDUSTRIAL APPLICABILITY

According to one of the embodiments of the present disclosure, it is useful to reduce a load on a developer for generating an animation of an object while sufficiently ensuring the degree of freedom in designing the object.

What is claimed is:

1. A non-transitory computer-readable medium storing an animation generating program for causing a server to perform functions comprising:
registering operation information including content of an operation for object parts of an object in a virtual space, the object parts comprising one or more joint sites;
obtaining the operation information for identifying the operation to be performed by the object parts; and
generating a part animation of each object part of the object parts configured to perform an operation among the object parts of the object, comprising:
dynamically calculating one or more rotation angles of one or more joint sites for the operation of the object parts in accordance with a predetermined calculation rule;
controlling the operation of the object parts using the part animations for the object parts; and
generating an animation of the object based on the part animations.

2. The non-transitory computer-readable medium according to claim 1,
wherein the operation information is identified by first command information on a command instructing the operations for a plurality of the object parts.

3. The non-transitory computer-readable medium according to claim 2,
wherein the operation information is identified by second command information on a command, the second command information including a plurality of kinds of the first command information.

4. The non-transitory computer-readable medium according to claim 1,
wherein the operation information comprises information on one or more mathematical functions for performing the operation by the object, and
wherein the calculation rule comprises the one or more mathematical functions.

5. The non-transitory computer-readable medium according to claim 1, wherein the calculation rule comprises:
obtaining information on at least one of a position or a posture of the object parts and information on surrounding environment of the object parts; and
executing calculation to dynamically perform the operation based on the obtained information.

6. The non-transitory computer-readable medium according to claim 1, wherein generating the part animation comprises:
prioritizing one operation among a plurality of the operations having at least a portion of execution periods to overlap one another based on a predetermined priority order upon a receipt of a command to start another operation for an object part of the object parts during the operation for the object part; and
controlling the object part to perform the prioritized operation from the portion of execution periods to overlap one another.

7. The non-transitory computer-readable medium according to claim 1, wherein the calculation rule comprises:
if the operation identifies a coordinate of a predetermined region of the object parts in a target posture or a direction of a movement of the predetermined region, calculating a rotation angle of the joint site of the object parts for movement of the predetermined region to a position associated with the coordinate or the movement of the predetermined region in the direction, respectively.

8. The non-transitory computer-readable medium according to claim 1, wherein the calculation rule comprises:
if the operation identifies a rotation angle of the joint site of the object parts in a target posture is specified by the specified operation, calculating an amount of rotation of each joint site of the joint sites to reach a target posture based on the information on the rotation angle of the joint site.

9. The non-transitory computer-readable medium according to claim 1, the functions further comprising:
determining occurrence of abnormality in the animation based on a state of at least one of a bone or the joint site in the object in the generated.

10. The non-transitory computer-readable medium according to claim 9, wherein determining the occurrence of abnormality is based on whether a difference between rotation angles of at least one of the bone or the joint site at two points of time in a predetermined time interval in the generated animation exceeds a predetermined threshold value.

11. The non-transitory computer-readable medium according to claim 9,
wherein determining the occurrence of abnormality in rotation of the bone is based on whether a rotation angle of at least one of the bone or the joint site in the generated animation exceeds a predetermined degree.

12. The non-transitory computer-readable medium according to claim 1, the functions further comprising:
storing the operation information or a combination of a plurality of the operations to generate the animation satisfying a predetermined standard of the part animation or the animation of the object in a predetermined storage.

13. The non-transitory computer-readable medium according to claim 1, the functions further comprising:
registering aim information for each posture state of a plurality of posture states when a combination of rotation angles of joint sites are changed in one or more angles, the aim information comprises:
first information related to a rotation angle of each joint site of the joint sites;
second information related to either a predetermined region of a predetermined object part of the object parts or a position of a portion of an accompanying object that accompanies the object parts; and
third information related to an aim direction associated with the first and second information, the aim direction being a direction of a movement of either the predetermined region or a direction of a movement of the portion of the accompanying object;
obtaining an aim command to cause the predetermined region or the portion of the accompanying object to move in a command aim direction;
obtaining the aim information for calculation based on the command aim direction; and
obtaining the operation information based on the obtained aim information.

14. An animation generating system comprising:
a communication network;
a server;
a user terminal; and
one or more processors configured to:
register operation information including content of an operation for the object parts of an object in a virtual space, the object parts comprising one or more joint sites;
obtain the operation information for identifying the operation to be performed by the object parts;
dynamically calculate one or more rotation angles of one or more joint sites for the operation of the object parts in accordance with a predetermined calculation rule;
generate a part animation of each object part of the object parts configured to perform the operation among the object parts of the object;
control the operation of the object parts using the part animations for the object parts; and
generate an animation of the object based on the part animations of the object parts.

15. A non-transitory computer-readable medium storing an animation generating program for causing a user terminal to perform functions comprising:
registering operation information including content of an operation for object parts of an object in a virtual space, the object parts comprising one or more joint sites;
obtaining the operation information for identifying the operation to be performed by the object parts; and
generating a part animation of each object part of object parts configured to perform an operation among the object parts of the object, comprising:
dynamically calculating one or more rotation angles of joint sites for the operation of the object parts in accordance with a predetermined calculation rule;
controlling the operation of the object parts using the part animations for the object parts; and
generating an animation of the object based on the part animations.
